(19) United States
(12) Patent Application Publication
(10) Pub. No.: US 2018/0165224 A1
(43) Pub. Date: Jun. 14, 2018

(54) SECURE ENCRYPTED VIRTUALIZATION

(71) Applicant: ATI Technologies ULC, Markham (CA)

(72) Inventors: Randall Brown, Toronto (CA); William Ng, Richmond Hill (CA)

(21) Appl. No.: 15/375,593

(22) Filed: Dec. 12, 2016

(51) Int. Cl. G06F 12/14; H04L 29/06; H04L 9/32

(52) U.S. Cl. CPC G06F 12/1408; G06F 2212/1052; H04L 9/3234; H04L 63/061

(57) ABSTRACT

Systems, apparatuses, and methods for implemented secure encrypted virtualization are disclosed. In one embodiment, a system includes at least one or more main processors, a memory, a memory controller, and a security processor. The system is configured to detect a request to provision a guest virtual machine (VM) in a secure environment. The system computes a first integrity check value from the guest VM prior to initiating the guest VM. The system initiates the guest VM responsive to receiving an indication that the first integrity check value is valid. The system encrypts, with a first encryption key, the guest VM stored in the memory. The security processor loads the first encryption key into the memory controller, and the memory controller encrypts the guest VM with the first encryption key.

### BACKGROUND

### Description of the Related Art

Virtualization is used in computer systems for a variety of different purposes. For example, virtualization can be used to execute privileged software in a container to prevent the privileged software from directly accessing and/or making changes to at least some of the physical machine state without first being permitted to do so by a virtual machine manager (VMM) (i.e., hypervisor) that controls the virtual machine. Such a container can prevent malicious software from causing problems on the physical machine. Additionally, virtualization can be used to permit two or more privileged programs to execute on the same physical machine concurrently. The privileged programs can be prevented from interfering with each other since access to the physical machine is controlled. Privileged programs can include operating systems, and can also include other software which expects to have full control of the hardware on which the software is executing. In another example, virtualization can be used to execute a privileged program on hardware that differs from the hardware expected by the privileged program.

Generally, virtualization of a processor or computer system includes providing one or more privileged programs with access to a virtual machine (the container mentioned above) over which the privileged program has full control, but the control of the physical machine is retained by the VMM. The virtual machine can include a processor (or processors), memory, and various peripheral devices that the privileged program expects to find in the machine on which it is executing. The virtual machine elements can be implemented by hardware that the VMM allocates to the virtual machine, at least temporarily, and/or may be emulated in software.

Both the VMM and the guests are executed by the processor(s) included in the physical machine. Accordingly, switching between execution of the VMM and the execution of guests occurs in the processor(s) over time. Particularly, the VMM schedules a guest for execution, and a switch to executing that guest is performed. At various points in time, a switch from executing a guest to executing the VMM also occurs so that the VMM can retain control over the physical machine (e.g., when the guest attempts to access a peripheral device, when a new page of memory is to be allocated to the guest, when it is time for the VMM to schedule another guest). A switch between a guest and the VMM (in either direction) is often referred to as a “world switch”.

In some cases, guests are run in an untrusted system. In these cases, a malicious user can exploit a vulnerability in the VMM to access one or more guests. Accordingly, techniques for protecting the guest from the VMM are desired.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one embodiment of a computing system.

FIG. 2 is a block diagram of one embodiment of a computer system that implements virtualization.

FIG. 3 is a block diagram of one embodiment of a computer system.

FIG. 4 is a block diagram of one embodiment of a system.

FIG. 5 is a generalized flow diagram illustrating one embodiment of a method for running a guest VM.

FIG. 6 is a generalized flow diagram illustrating one embodiment of a method for protecting a guest register state.

FIG. 7 is a generalized flow diagram illustrating one embodiment of a method for resuming a guest VM.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Various systems, apparatuses, methods, and computer-readable mediums for implementing secure encrypted virtualization are disclosed. In one embodiment, a system includes at least one or more main processors, a security processor, system memory, and a memory controller. In one embodiment, the system manages encryption keys and encrypts each virtual machine (VM) running on the machine with a key unique to that virtual machine when the virtual machine is stored in system memory. By encrypting the virtual machines in system memory, the system isolates VMs from the hypervisor such that only the VM can access its data stored in system memory.

In one embodiment, a system is configured to detect a request to provision a guest virtual machine (VM) in a secure environment. The system computes a first integrity check value from the guest VM prior to launching the guest VM. The system launches the guest VM responsive to receiving an indication that the first integrity check value is valid. Then, the system encrypts, with a first encryption key, the guest VM stored in the memory. In one embodiment, the security processor loads the first encryption key into the memory controller, and the memory controller encrypts the guest VM with the first encryption key.

In one embodiment, the system receives a request to exit the guest VM. Next, the system encrypts a guest register state of the guest VM when storing the guest register state to the memory. In one embodiment, the guest register state is encrypted with the first encryption key, which is the same memory encryption key used to encrypt the guest VM. In one embodiment, the system is configured to compute an integrity check value from the guest register state. The system is further configured to store the integrity check value in a protected region of the memory. The system is configured to prevent the guest VM from being resumed responsive to determining the integrity check value is invalid. For example, if a malicious hypervisor tries to modify the stored guest register state, the system will detect a discrepancy between the stored integrity check value and an integrity check value computed after reloading the guest register state into the processor's registers. Additionally, in one embodiment, the system is configured to encrypt a first portion of a virtual machine control block (VMCB) of the guest VM when storing the VMCB to the memory. Also, in this embodiment, the system is configured to store, in an unencrypted state, a second portion of the VMCB in the memory.

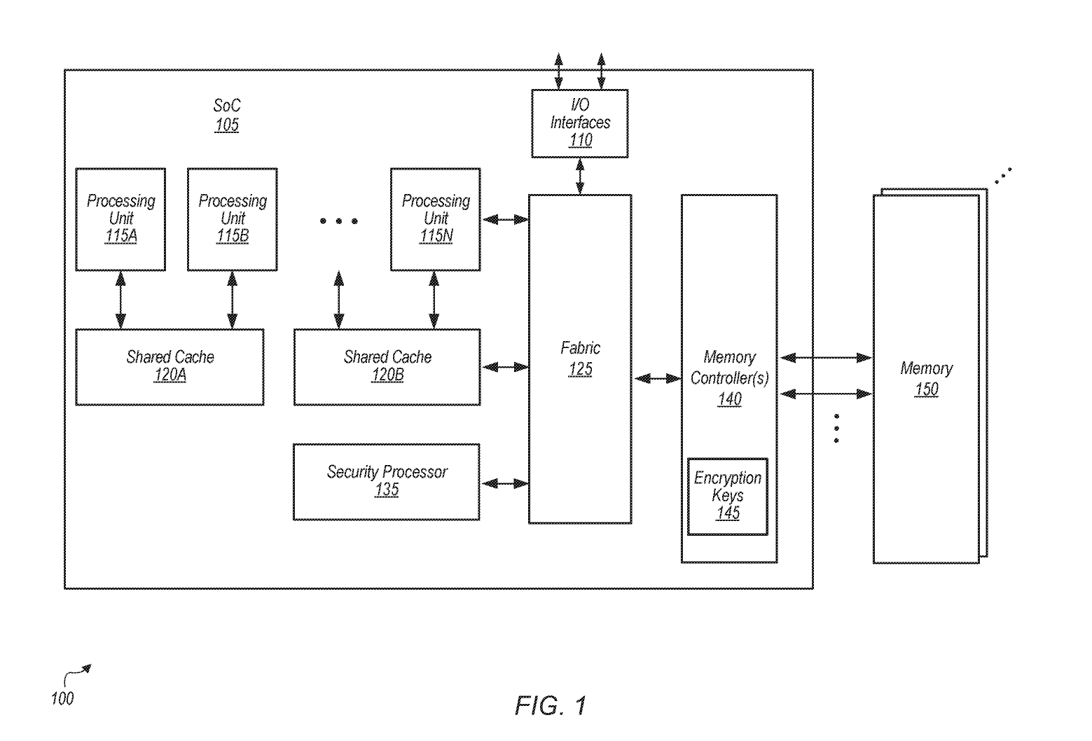

Referring now to FIG. 1, a block diagram of one embodiment of a computing system 100 is shown. In one embodiment, computing system 100 includes system on chip (SoC) 105 coupled to memory 150. SoC 105 can also be referred to as an integrated circuit (IC). In one embodiment, SoC 105 includes processing units 115A-N, input/output (I/O) interfaces 110, shared caches 120A-B, fabric 125, security processor 135, and memory controller(s) 140. SoC 105 can also include other components not shown in FIG. 1 to avoid obscuring the figure. Processing units 115A-N are representative of any number and type of processing units. In one embodiment, processing units 115A-N are central processing unit (CPU) cores. In another embodiment, one or more of processing units 115A-N are other types of processing units (e.g., graphics processing unit (GPU), application specific integrated circuit (ASIC), field programmable gate array (FPGA), digital signal processor (DSP)). Processing units 115A-N are coupled to shared caches 120A-B and fabric 125.

In one embodiment, processing units 115A-N are configured to execute instructions of a particular instruction set architecture (ISA). Each processing unit 115A-N includes one or more execution units, cache memories, schedulers, branch prediction circuits, and so forth. In one embodiment, the processing units 115A-N are configured to execute the main control software of system 100, such as an operating system. Generally, software executed by processing units 115A-N during use can control the other components of system 100 to realize the desired functionality of system 100. Processing units 115A-N can also execute other software, such as application programs.

I/O interfaces 110 are coupled to fabric 125. I/O interfaces 110 are representative of any number and type of interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices can be coupled to I/O interfaces 110. Such peripheral devices include (but are not limited to) displays, keyboards, mice, printers, scanners, joysticks or other types of game controllers, media recording devices, external storage devices, network interface cards, and so forth.

In one embodiment, security processor 135 is configured to manage the configuration and security of system 100. In various embodiments, security processor 135 is preloaded with any number of public/private encryption keys and/or generates any number and type of encryption keys. As used herein, the term “security processor” is defined as an apparatus configured to execute instructions for performing authentication and validation functions which provide security protection for system 100. A processing unit 115A-N is differentiated from a security processor, with the processing unit executing operating system instructions, user application instructions, etc. An additional differentiating factor between a main processor and security processor 135 is that security processor 135 includes one or more security-related mechanisms (e.g., random number generator, cryptographic coprocessor). Also, security processor 135 stores one or more unique encryption/decryption keys inaccessible to the rest of system 100. Accordingly, security processor 135 provides a hardware-based root of trust for system 100, allowing guest VMs executing on system 100 to execute in a secure environment.

In one embodiment, security processor 135 is configured to load encryption keys 145 in memory controller 140, and memory controller 140 is configured to encrypt guest VMs with encryption keys 145. In one embodiment, each guest VM has its own encryption key stored by memory controller in encryption keys 145. In one embodiment, the encryption key for a guest VM is also used to encrypt the guest register state of the guest VM when the guest VM exits and a hypervisor or other guest VM starts executing on system 100.

In some embodiments, memory 150 includes a plurality of memory modules. Each of the memory modules includes one or more memory devices mounted thereon. In some embodiments, memory 150 includes one or more memory devices mounted on a motherboard or other carrier upon which SoC 105 is also mounted. In one embodiment, memory 150 is used to implement a random access memory (RAM) for use with SoC 105 during operation. The RAM implemented can be static RAM (SRAM), dynamic RAM (DRAM), Resistive RAM (ReRAM), Phase Change RAM (PCRAM), or any other volatile or non-volatile RAM. The type of DRAM that is used to implement memory 150 includes (but is not limited to) double data rate (DDR) DRAM, DDR2 DRAM, DDR3 DRAM, and so forth. Although not explicitly shown in FIG. 1, SoC 105 can also include one or more cache memories that are internal to the processing units 115A-N. In some embodiments, SoC 105 includes shared caches 120A-B that are utilized by processing units 115A-N. In one embodiment, caches 120A-B are part of a cache subsystem including a cache controller.

In various embodiments, computing system 100 can be a computer, laptop, mobile device, server, web server, cloud computing server, storage system, or any of various other types of computing systems or devices. It is noted that the number of components of computing system 100 and/or SoC 105 can vary from embodiment to embodiment. There can be more or fewer of each component/subcomponent than the number shown in FIG. 1. For example, in another embodiment, SoC 105 can include multiple memory controllers coupled to multiple memories. It is also noted that computing system 100 and/or SoC 105 can include other components not shown in FIG. 1. Additionally, in other embodiments, computing system 100 and SoC 105 can be structured in other ways than shown in FIG. 1.

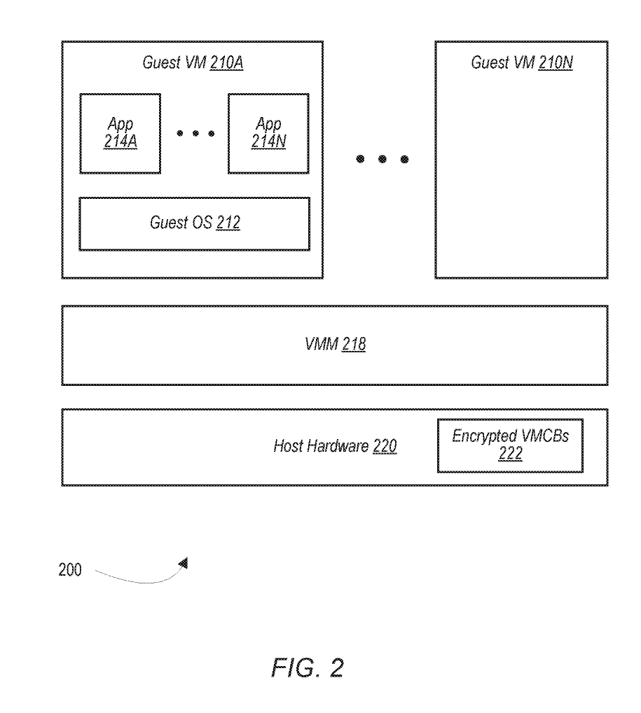

Turning now to FIG. 2, a block diagram of one embodiment of a computer system 200 that implements virtualization is shown. In the embodiment of FIG. 2, multiple guest VMs 210A-210N are shown. Guest VM 210A includes a guest operating system (OS) 212 and one or more applications 214A-214N that run on the guest OS 212. The other guest VMs 210A-210N can include similar software. The guest VMs 210A-210N are managed by a virtual machine manager (VMM) 218. The VMM 218 and the guest VMs 210A-210N execute on host hardware 220, which can include the physical hardware included in the computing system 200. In one embodiment, computer system 200 is part of a cloud computing environment.

In one embodiment, the VMM 218 and guest VMs 210A-210N maintain a set of virtual machine control blocks (VMCBs) 222. There can be one VMCB 222 for each guest VM 210A-210N. In one embodiment, there can be one VMCB 222 for each virtual CPU (vCPU) in each guest VM 210A-210N. When a given guest exits, the VMCB 222 for the given guest VM is encrypted and stored in system memory of the host hardware 220. In one embodiment, a first portion of the VMCB 222 is encrypted and a second portion of the VMCB 222 is stored in an unencrypted state. The unencrypted state of the VMCB 222 is used for communication between VMM 218 and the given guest VM. By encrypting at least a portion of VMCB 222 with an encryption key inaccessible to VMM 218, a malicious user who exploits a flaw in VMM 218 is unable to access or modify the encrypted portion VMCB 222, preventing the malicious user from gaining control over the corresponding guest VM or access to its data.

The host hardware 220 generally includes all of the hardware included in the computer system 200. In various embodiments, the host hardware 220 includes one or more processors, memory, peripheral devices, storage, and other circuitry used to connect together the preceding components. For example, personal computer (PC)-style systems can include a switch fabric coupling the processors, the memory, and a graphics device that uses an interface such as a peripheral component interface (PCI) Express Interface. Additionally, the switch fabric couples to a peripheral bus such as the PCI bus, to which various peripheral components are directly or indirectly coupled. In other embodiments, other circuitry can be used to link various hardware components. For example, HyperTransport™ (HT) links can be used to link nodes, each of which include one or more processors, a host bridge, and a memory controller. Each node can also include a switch fabric or a Northbridge. The host bridge can be used to couple, via HT links, to peripheral devices in a daisy chain fashion. Alternatively, many of the components can be included on a single device such as, for example, a single device that integrates one or more processors, Northbridge functionality and a graphics device. Any desired circuitry/host hardware structure can be used.

The VMM 218 is configured to provide the virtualization for each of the guest VMs 210A-210N. The VMM 218 is also responsible for scheduling the guest VMs 210A-210N for execution on the host hardware 220 (and more particularly, vCPUs within the guests if the guests include more than one vCPU). The VMM 218 is configured to use the hardware support provided in the host hardware 220 for virtualization. For example, the processors can provide hardware support for virtualization, including hardware to intercept events and exit the guest to the VMM 218 for notification purposes.

In some embodiments, the VMM 218 is implemented as a “thin” standalone software program that executes on the host hardware 220 and provides the virtualization for the guest VM 210A-210N. Such a VMM implementation can be referred to as a “hypervisor”. In other embodiments, the VMM 218 is integrated into or execute on a host OS. In such embodiments, the VMM 218 relies on the host OS, including any drivers in the host OS, platform system management mode (SMM) code provided by the system BIOS, etc. Thus, the host OS components (and various lower-level components such as the platform SMM code) execute directly on the host hardware 220 and are not virtualized by the VMM 218. The VMM 218 and the host OS (if included) can together be referred to as the host, in one embodiment. Generally, the host includes any code that is in direct control of the host hardware 220 during use. For example, the host can be the VMM 218, the VMM 218 in conjunction with the host OS, or the host OS alone (e.g., in a non-virtualized environment).

In various embodiments, the VMM 218 can support full virtualization, paravirtualization, or both. Furthermore, in some embodiments, the VMM 218 concurrently executes guest that are paravirtualized and guest that are fully virtualized. With full virtualization, the guest VM 210A-210N is not aware that virtualization is occurring. Each guest VM 210A-210N has contiguous, zero based memory in its virtual machine, and the VMM 218 uses shadow page tables or nested page tables to control access to the host physical address space. The shadow page tables remap from guest virtual addresses to host physical addresses (effectively remapping the guest “physical address” assigned by memory management software in the guest VM 210A-210N to host physical address), while nested page tables receive the guest physical address as an input and map to the host physical address. Using the shadow page tables or nested page tables for each guest VM 210A-210N, the VMM 218 ensures that guests do not access other guests' physical memory in the host hardware 220.

With paravirtualization, guest VMs 210A-210N are at least partially VM-aware. Such guest VMs 210A-210N negotiate for memory pages with the VMM 218, and thus remapping guest physical addresses to host physical addresses is not required. In one embodiment, in paravirtualization, guest VMs 210A-210N are permitted to directly interact with peripheral devices in the host hardware 220. At any given time, a peripheral device is “owned” by a guest or guest VMs 210A-210N. In one implementation, for example, a peripheral device is mapped into a protection domain with one or more guest VMs 210A-210N that currently own that peripheral device. There is also a protection mechanism to prevent devices in a protection domain from reading/writing pages allocated to a guest in another protection domain.

As mentioned previously, a VMCB 222 is maintained for each guest VM 210A-210N and/or each vCPU in the guest. The VMCB 222 includes a data structure encrypted and stored in a storage area that is allocated for the corresponding guest VM 210A-210N. In one embodiment, the VMCB 222 includes a page of memory, although other embodiments can use larger or smaller memory areas and/or use storage on other media such as non-volatile storage. In one embodiment, the VMCB 222 includes the guest register state, which is decrypted and loaded into a processor in the host hardware 220 when the guest is scheduled to execute and is encrypted and stored back to the VMCB 222 when the guest exits (either due to completing its scheduled time, or due to an intercept or other event that the processor detects for exiting the guest).

In one embodiment, the VMM 218 also has an area of memory allocated to store the processor state corresponding to the VMM 218. When the guest is scheduled for execution, the processor state corresponding to the VMM 218 is saved in this area. In one embodiment, an instruction or utility (e.g., VMRUN) is used to start execution of a guest. When the guest exits to the VMM 218, the stored processor state is reloaded to permit the VMM 218 to continue execution. In one implementation, for example, the processor implements a register (e.g., a model specific register, or MSR) to store the address of the VMM 218 save area.

Additionally, the VMCB 222 includes an intercept configuration that identifies fault or trap events that are enabled for the guest, and the mechanism for exiting the guest if an enabled event is detected. In one embodiment, the intercept configuration includes a set of intercept indications, one indication for each event that the processor supports. The intercept indication indicates whether or not the processor is to intercept the corresponding event (or, viewed in another way, whether or not the intercept is enabled). The VMM 218 configures the processor to intercept those events that the VMM 218 wishes to be notified about when performed by a guest VM 210A-210N. Events include instructions, interrupts, exceptions, faults, traps, and/or any other actions that occur during guest VM execution.

Generally, a “guest VM” or a “guest” includes any one or more software programs that are to be virtualized for execution in the computer system 200. A guest VM includes at least some code that executes in privileged mode, and thus expects to have full control over the computer system on which it is executing. As mentioned previously, guest VM 210A is an example in which the guest VM includes a guest OS 212. The guest OS 212 can be any OS, such as Windows®, UNIX®, Linux®, etc. The guest VMs 210A-210N also execute non-OS privileged code.

It is noted that the letter “N” when used herein in reference numerals such as 210N is meant to generically indicate any number of elements bearing that reference numeral (e.g., any number of guest VMs 210A-210N, including one guest VM). Additionally, different reference numerals that use the letter “N” (e.g., 210N and 214N) are not intended to indicate equal numbers of the different elements are provided (e.g., the number of guest VMs 210A-210N can differ from the number of applications 214A-214N) unless otherwise noted.

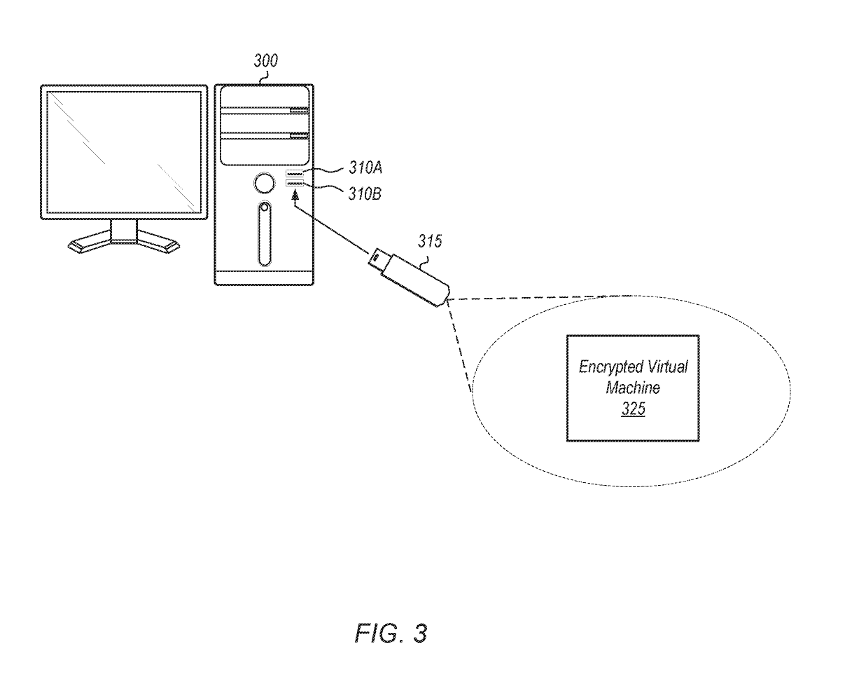

Referring now to FIG. 3, a block diagram of one embodiment of a computer system 300 is shown. In one embodiment, system 300 includes the circuitry shown in system 100 (of FIG. 1). While computer system 300 is shown as a desktop computer in FIG. 3, it should be understood that computer system 300 is representative of any type of computer system. In other embodiments, computer system 300 can be a laptop, server, or other system or device with at least one processor, one or more memory devices, one or more input/output (I/O) ports (e.g., universal serial bus (USB) ports), and a display device. As shown in FIG. 3, computer system 300 includes I/O ports 310A-B, which are representative of any number and type of I/O ports. In one embodiment, one or more of I/O ports 310A-B are USB ports.

In one embodiment, a user of computer system 300 plugs USB device 315 into USB port 310 so as to run encrypted virtual machine (VM) 325 on computer system 300. In one embodiment, computer system 300 is infected with malware. However, encrypted VM 325 can still run securely on computer system 300 although system 300 is infected with malware. In one embodiment, if system 300 is infected with malware, encrypted VM 325 runs on system 300 to remove the malware, return system 300 to a stable state, and/or retrieve data from system 300 in a secure manner.

In one embodiment, computer system 300 generates an identity check value (i.e., secure hash) from encrypted VM 325 prior to executing encrypted VM 325. The user can verify that the identity check value is valid prior to allowing encrypted VM 325 to start executing on system 300. Then, if the identity check value is validated, encrypted VM 325 can be decrypted and then re-encrypted by the memory controller when encrypted VM 325 is loaded into the system memory of system 300 and executed by the processor(s) of system 300. When encrypted VM 325 exits to the hypervisor, the guest register state of encrypted VM 325 is encrypted with the same encryption key as encrypted VM 325, and then the encrypted guest register state is stored in a protected region of system memory. Encrypting the guest register state of encrypted VM 325 prevents a malicious hypervisor from accessing and/or modifying the guest register state of encrypted VM 325.

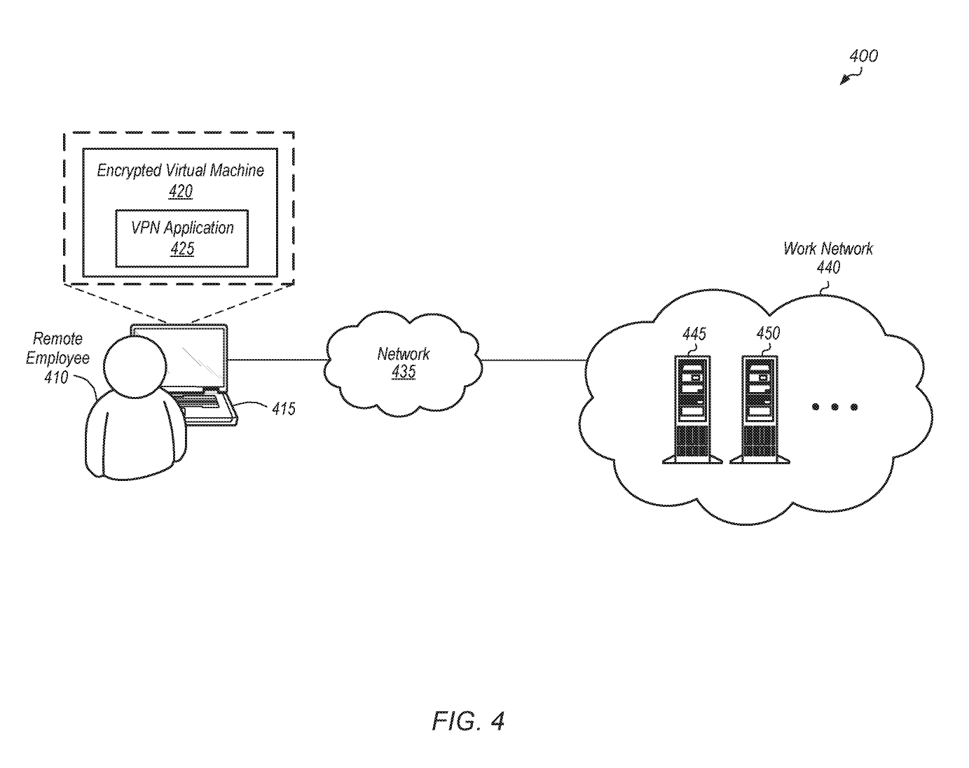

Turning now to FIG. 4, a block diagram of one embodiment of a system 400 is shown. In one embodiment, a remote employee 410 utilizes a computer 415 to login to a work network 440. Work network 440 includes at least servers 445 and 450 to host the resources of a company or other organization. Computer 415 includes encrypted VM 420 with virtual private network (VPN) application 425. Encrypted VM 420 is a secure VM which is protected against attacks by other software applications running on computer 415. In one embodiment, computer 415 includes the components of system 100 (of FIG. 1) for encrypting and protecting encrypted VM 420 during operation.

In one embodiment, employee 415 utilizes network 435 to connect to work network 440. Network 435 can be any type of network or combination of networks, including wireless connection, direct local area network (LAN), metropolitan area network (MAN), wide area network (WAN), a Public Switched Telephone Network (PSTN), an Intranet, the Internet, a cable network, a packet-switched network, a fiber-optic network, a router, storage area network, or other type of network. Examples of LANs include Ethernet networks, Fiber Distributed Data Interface (FDDI) networks, and token ring networks. Network 435 can further include remote direct memory access (RDMA) hardware and/or software, transmission control protocol/internet protocol (TCP/IP) hardware and/or software, router, repeaters, switches, grids, and/or others.

In one embodiment, before allowing remote employee 410 to login to work network 440 using VPN application 425, software executing on servers 445 and/or 450 authenticates encrypted VM 420. In one embodiment, an integrity check value of encrypted VM 420 is sent to work network 440 for validation. If the integrity check value is valid, then remote employee 410 provides their credentials to login to work network 440. However, if the integrity check value is invalid, which means encrypted VM 420 has been altered in some manner, then remote employee 410 is prevented from logging in to work network 440.

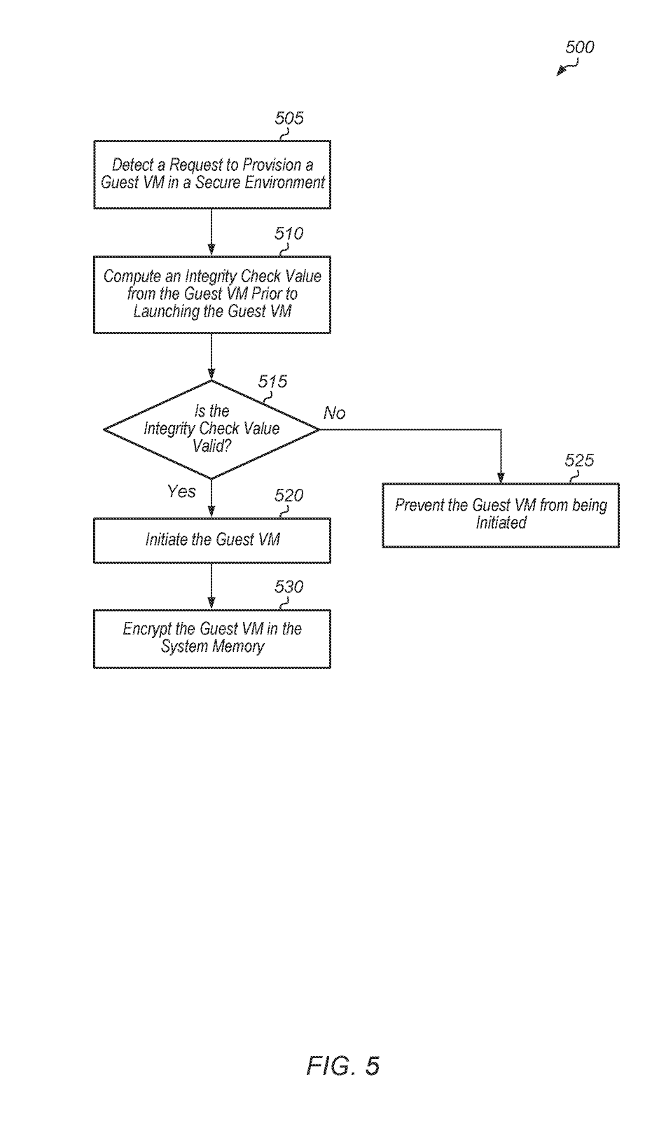

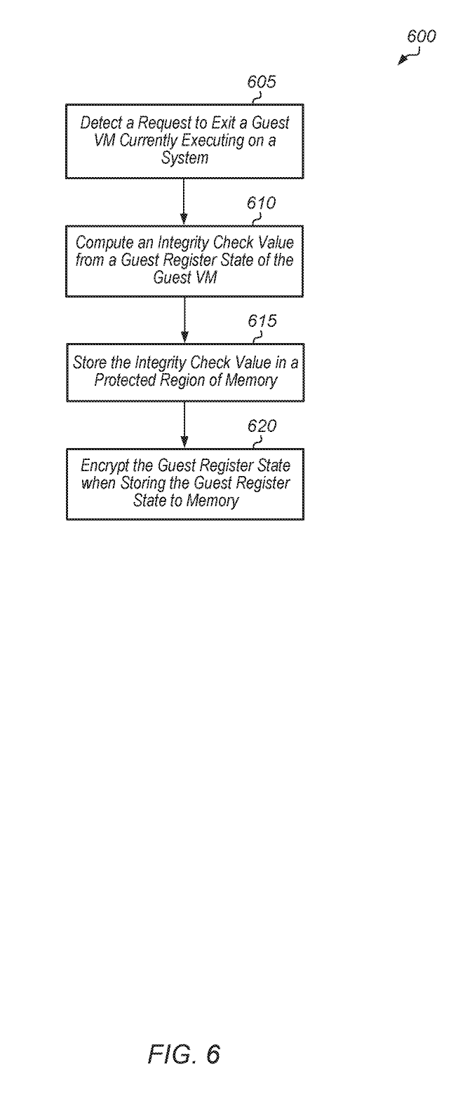

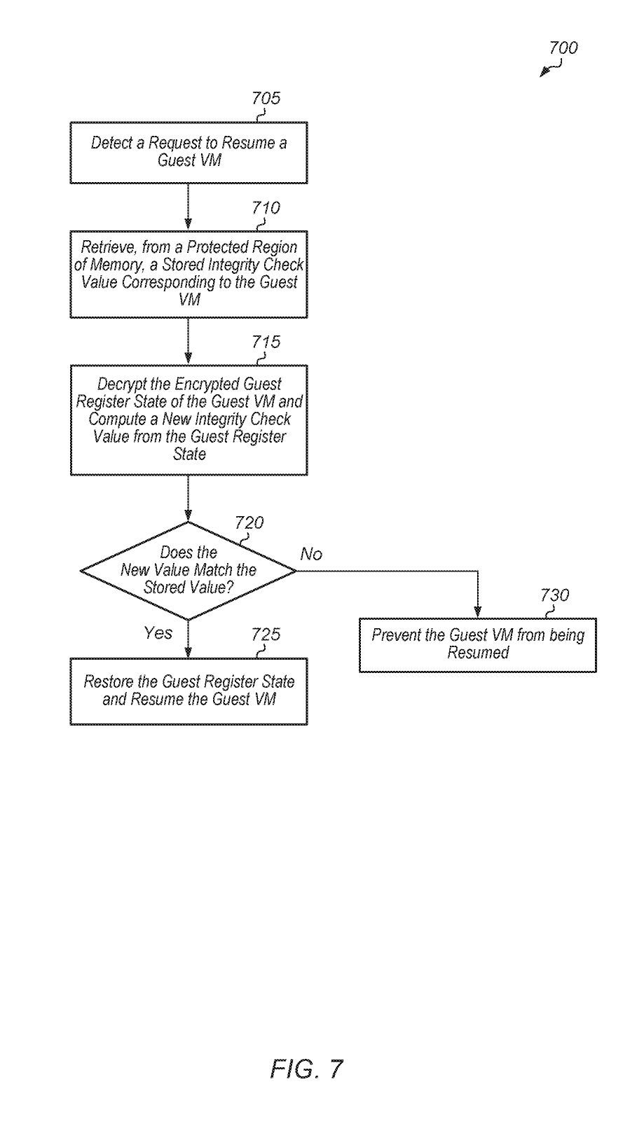

Referring now to FIG. 5, one embodiment of a method 500 for running a guest VM is shown. For purposes of discussion, the steps in this embodiment and those of FIGS. 6-7 are shown in sequential order. However, it is noted that in various embodiments of the described methods, one or more of the elements described are performed concurrently, in a different order than shown, or are omitted entirely. Other additional elements are also performed as desired. Any of the various systems or apparatuses described herein are configured to implement method 500.

A computing system detects a request to provision a guest virtual machine (VM) in a secure environment (block 505). In one embodiment, provisioning the guest VM involves allocating resources (e.g., memory, vCPUs) for the guest VM. In one embodiment, the computing system includes at least one or more main processors, a memory, a memory controller, and a security processor. In one embodiment, the computing system is part of a cloud-computing environment. For example, in this embodiment, the computing system is configured to offer cloud computing resources to various users. Cloud computing is the delivery of computing as a service where shared resources, software, and information are provided to computers and other devices over a network. Cloud computing provides computation, software, data access, and data storage services. In other embodiments, the computing system is a server, computer, mobile device, or another type of computing system or device.

Next, the system computes an integrity check value from the guest VM prior to launching the guest VM (block 510). Then, the system determines if the first integrity check value is valid (conditional block 515). In one embodiment, the system sends the first integrity check value to the owner of the guest VM and waits to receive a reply from the owner that the first integrity check value is a valid. In another embodiment, the system compares the first integrity check value to a value generated by the security processor. In other embodiments, other techniques for determining the validity of the first integrity check value are possible and are contemplated.

If the first integrity check value is valid (conditional block 515, “yes” leg), then the system initiates the guest VM (block 520). If the first integrity check value is invalid (conditional block 515, “no” leg), then the system prevents the guest VM from being launched (block 525). The system can also notify the owner of the guest VM that the first integrity check value was invalid. After block 520, the system encrypts the guest VM in the system memory (block 530). In one embodiment, the security processor loads an encryption key for encrypting the guest VM into the memory controller, and the memory controller encrypts the guest VM with the encryption key. In other embodiments, other techniques for encrypting the guest VM stored in the system memory are possible and are contemplated. After block 530, method 500 ends.

Turning now to FIG. 6, one embodiment of a method 600 for protecting a guest register state is shown. A system detects a request to exit a guest virtual machine (VM) currently executing on the system (block 605). In response to detecting the request to exit the guest VM, the system computes an integrity check value from a guest register state of the guest VM (block 610). Then, the system stores the integrity check value in a protected region of memory (block 615). The protected region of memory refers to a region of memory inaccessible by the hypervisor. Additionally, in response to detecting the request to exit the guest VM, the system encrypts a guest register state of the guest VM when storing the guest register state to memory (block 620). In one embodiment, the system encrypts the guest register state of the guest VM with the same encryption key used to encrypt the guest VM in the system memory. After block 620, method 600 ends.

Turning now to FIG. 7, one embodiment of a method 700 for resuming a guest VM is shown. A system detects a request to resume a guest VM (block 705). In response to detecting the request, the system retrieves a stored integrity check value corresponding to the guest VM from a protected region of memory (block 710). The system also decrypts the encrypted guest register state of the guest VM and computes a new integrity check value from the guest register state (block 715).

If the new integrity check value matches the stored integrity check value (conditional block 720, “yes” leg), then the system restores the guest register state and resumes the guest VM (block 725). If the new integrity check value does not match the stored integrity check value (conditional block 725, “no” leg), then the system prevents the guest VM from being resumed (block 730). After blocks 725 and 730, method 700 ends.

In various embodiments, program instructions of a software application are used to implement the methods and/or mechanisms previously described. The program instructions describe the behavior of hardware in a high-level programming language, such as C. Alternatively, a hardware design language (HDL) is used, such as Verilog. The program instructions are stored on a non-transitory computer readable storage medium. Numerous types of storage media are available. The storage medium is accessible by a computing system during use to provide the program instructions and accompanying data to the computing system for program execution. The computing system includes at least one or more memories and one or more processors configured to execute program instructions.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
one or more processors; and
a memory;
wherein the system is configured to:
detect a request to provision a guest virtual machine (VM) in a secure environment;
compute a first integrity check value from the guest VM prior to launching the guest VM;
initiate the guest VM responsive to receiving an indication that the first integrity check value is valid; and
responsive to initiating the guest VM on the one or more processors, encrypt, with an encryption key, the guest VM stored in the memory.

2. The system as recited in claim 1, wherein the system further comprises:
a memory controller; and
a security processor configured to load the encryption key into the memory controller;
wherein the memory controller is configured to encrypt the guest VM with the first encryption key.

3. The system as recited in claim 2, wherein the system is configured to prevent a hypervisor from accessing the encryption key.

4. The system as recited in claim 3, wherein the system is further configured to:
detect a request to exit the guest VM; and
encrypt, with the encryption key, a guest register state of the guest VM when storing the guest register state to the memory.

5. The system as recited in claim 4, wherein the system is further configured to compute a second integrity check value from the guest register state.

6. The system as recited in claim 5, wherein the system is further configured to store the second integrity check value in a protected region of the memory.

7. The system as recited in claim 6, wherein responsive to detecting a request to resume the guest VM, the system is configured to validate the integrity check value prior to restoring the guest register state.

8. A method comprising:
detecting a request to provision a guest virtual machine (VM) in a secure environment;
computing a first integrity check value from the guest VM prior to launching the guest VM;
initiating the guest VM responsive to receiving an indication that the first integrity check value is valid; and
responsive to initiating the guest VM on the one or more processors, encrypting, with an encryption key, the guest VM stored in memory.

9. The method as recited in claim 8, further comprising:
loading the encryption key into a memory controller; and
encrypting, by the memory controller, the guest VM with the encryption key.

10. The method as recited in claim 9, further comprising preventing a hypervisor from accessing the encryption key.

11. The method as recited in claim 10, further comprising:
detecting a request to exit the guest VM; and
encrypting, with the encryption key, a guest register state of the guest VM when storing the guest register state to the memory.

12. The method as recited in claim 11, further comprising computing a second integrity check value from the guest register state.

13. The method as recited in claim 12, further comprising storing the second integrity check value in a protected region of the memory.

14. The method as recited in claim 13, wherein responsive to detecting a request to resume the guest VM, the method further comprising validating the integrity check value prior to restoring the guest register state.

15. A non-transitory computer readable storage medium storing program instructions, wherein the program instructions are executable by a processor to:
detect a request to provision a guest virtual machine (VM) in a secure environment;
compute a first integrity check value from the guest VM prior to launching the guest VM;
initiate the guest VM responsive to receiving an indication that the first integrity check value is valid; and
responsive to initiating the guest VM on the one or more processors, encrypt, with an encryption key, the guest VM stored in memory.

16. The non-transitory computer readable storage medium as recited in claim 15, wherein the program instructions are further executable by a processor to:
load the encryption key into the memory controller; and
encrypt, by the memory controller, the guest VM with the encryption key.

17. The non-transitory computer readable storage medium as recited in claim 16, wherein the program instructions are further executable by a processor to prevent a hypervisor from accessing the encryption key.

18. The non-transitory computer readable storage medium as recited in claim 17, wherein the program instructions are further executable by a processor to:
detect a request to exit the guest VM; and
encrypt, with the encryption key, a guest register state of the guest VM when storing the guest register state to the memory.

19. The non-transitory computer readable storage medium as recited in claim 18, wherein the program instructions are further executable by a processor to compute a second integrity check value from the guest register state.

20. The non-transitory computer readable storage medium as recited in claim 19, wherein the program instructions are further executable by a processor to store the second integrity check value in a protected region of the memory.
